(19) United States
(12) Patent Application Publication
(10) Pub. No.: US 2025/0097732 A1
(43) Pub. Date: Mar. 20, 2025

(54) SYSTEMS AND METHODS FOR MACHINE LEARNING BASED SLICE MODIFICATION, ADDITION, AND DELETION

(71) Applicant: CommScope Technologies LLC, Claremont, NC (US)

(72) Inventor: Harsha Hegde, Hawthorn Woods, IL (US)

(73) Assignee: CommScope Technologies LLC, Claremont, NC (US)

(21) Appl. No.: 18/728,009

(22) PCT Filed: Jan. 24, 2023
(86) PCT No.: PCT/US2023/061148

§ 371 Date: Jul. 10, 2024

Related U.S. Application Data
(60) Provisional application No. 63/305,611, filed on Feb. 1, 2022.

(51) Int. Cl. H04W 24/02; H04L 41/147; H04L 41/5019; H04W 16/10

(52) U.S. Cl. CPC H04W 24/02; H04L 41/147; H04L 41/5019; H04W 16/10

(57) ABSTRACT

Systems and methods for machine learning based network slice modification, addition, and deletion are provided. In one example, a method includes receiving time data, traffic data, and QoS data and determining a predicted radio resource usage of a base station based on the time data, traffic data, and QoS data. The base station includes at least one BBU, radio unit(s) communicatively coupled to the at least one BBU, and antenna(s) communicatively coupled to the radio unit(s). Each respective radio unit is communicatively coupled to a respective subset of the antenna(s). The at least one BBU, the radio unit(s), and the antenna(s) are configured to implement a base station for wirelessly communicating with user equipment. The method further includes dynamically modifying, adding, or deleting one or more network slices based on the predicted radio resource usage of the base station.

### CROSS-REFERENCE TO RELATED APPLICATIONS

This application claims the benefit of U.S. Provisional Patent Application Ser. No. 63/305,611, filed on Feb. 1, 2022, entitled “SYSTEMS AND METHODS FOR MACHINE LEARNING BASED SLICE MODIFICATION, ADDITION, AND DELETION,” the entirety of which is incorporated herein by reference.

### BACKGROUND

A centralized or cloud radio access network (C-RAN) is one way to implement base station functionality. Typically, for each cell (that is, for each physical cell identifier (PCI)) implemented by a C-RAN, one or more baseband unit (BBU) entities (also referred to here simply as “BBUs”) interact with multiple remote units (also referred to here as “RUs,” “radio units,” “radio points,” or “RPs”) to implement a base station entity in order to provide wireless service to various items of user equipment (UEs). The BBU entities may comprise a single entity (sometimes referred to as a “baseband controller” or simply a “baseband band unit” or “BBU”) that performs Layer-3, Layer-2, and some Layer-1 processing for the cell. The BBU entities may also comprises multiple entities, for example, one or more central unit (CU) entities that implement Layer-3 and non-time critical Layer-2 functions for the associated base station and one or more distribution units (DU) that implement the time critical Layer-2 functions and at least some of the Layer-1 (also referred to as the Physical Layer) functions for the associated base station. Each CU can be further partitioned into one or more user-plane and control-plane entities that handle the user-plane and control-plane processing of the CU, respectively. Each such user-plane CU entity is also referred to as a “CU-UP,” and each such control-plane CU entity is also referred to as a “CU-CP.” In this example, each RU is configured to implement the radio frequency (RF) interface and the physical layer functions for the associated base station that are not implemented in the DU. The multiple RUs are typically located remotely from each other (that is, the multiple RUs are not co-located), and the BBU entities are communicatively coupled to the remote units over a fronthaul network. The RUs may also be collocated (for example, in instances where each RU processes different carriers or time slices).

### SUMMARY

In some aspects, a system includes at least one baseband unit (BBU), one or more radio units communicatively coupled to the at least one BBU, and one or more antennas communicatively coupled to the one or more radio units. Each respective radio unit of the one or more radio units is communicatively coupled to a respective subset of the one or more antennas. The at least one BBU, the one or more radio units, and the one or more antennas are configured to implement a base station for wirelessly communicating with user equipment. The system further includes a machine learning computing system configured to receive time data, traffic data, and quality of service data. The machine learning computing system is further configured to determine a predicted radio resource usage of the base station based on the time data, the traffic data, and the quality of service (QoS) data. The system is configured to dynamically modify, add, or delete a network slice based on the predicted radio resource usage of the base station.

In other aspects, a method includes receiving time data, traffic data, and quality of service data. The method further includes determining a predicted radio resource usage of a base station based on the time data, the traffic data, and the quality of service (QoS) data. The base station includes at least one baseband unit (BBU), one or more radio units communicatively coupled to the at least one BBU, and one or more antennas communicatively coupled to the one or more radio units. Each respective radio unit of the one or more radio units is communicatively coupled to a respective subset of the one or more antennas. The at least one BBU, the one or more radio units, and the one or more antennas are configured to implement a base station for wirelessly communicating with user equipment. The method further includes dynamically modifying, adding, or deleting one or more network slices based on the predicted radio resource usage of the base station.

In other aspects, a system includes a distributed antenna system. The distributed antenna system includes a master unit communicatively coupled to a base station and one or more remote antenna units communicatively coupled to the master unit. The one or more remote antenna units are located remotely from the master unit. The one or more remote antenna units are configured to communicate wireless signals with user equipment in one or more coverage zones. The system further includes a machine learning computing system configured to receive time data, traffic data, and quality of service data. The machine learning computing system is further configured to determine a predicted radio resource usage of the base station based on the time data, the traffic data, and the quality of service (QoS) data. The system is configured to dynamically modify, add, or delete a network slice based on the predicted radio resource usage of the base station.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1B are block diagrams illustrating example radio access networks;

FIG. 2 is a diagram of example variables for machine learning model;

FIG. 3 is a block diagram illustrating an example radio access network;

FIG. 4 is a flow diagram illustrating an example method of radio resource usage; and

FIG. 5 is a block diagram of an example distributed antenna system.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used, and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

In fifth generation (5G) New Radio (NR) campus and venue networks, network slices can be added or deleted through an orchestrator/controller that interacts with the core network, transport network, and RAN network. In the context of the present application, a network slice includes a share of transport resources (for example, dimensioning switches and routers to allocate certain transport paths to a set of traffic characteristics or use cases), core network resources (for example, number of compute instances required for a User Plane Function (UPF)), and radio access network resources (for example, number of compute instances required for a central unit user plane (CU-UP)). The orchestrator/controller is generally responsible for adding and deleting slices either statically or dynamically based on user needs that are defined by parameters (for example, latency, bandwidth, density, etc.) and tied to different use cases (for example, enhanced Mobile Broadband (eMBB), ultra-reliable low latency communications (URLLC), massive Machine Type Communications (mMTC), etc.). However, the act of adding or deleting the network slices is triggered by an operator based on expected need or demand and not based on the real-time traffic needs while meeting the required Service Level Agreement (SLA). This process requires additional operating expenses and can cause poor user experience in certain circumstances.

While the problems described above involve 5G NR systems, similar problems exist in LTE. Therefore, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future), and the following description is not intended to be limited to any particular mode. Also, unless explicitly indicated to the contrary, references to “layers” or a “layer” (for example, Layer-1, Layer-2, Layer-3, the Physical Layer, the MAC Layer, etc.) set forth herein refer to layers of the wireless interface (for example, 5G NR or 4G LTE) used for wireless communication between a base station and user equipment).

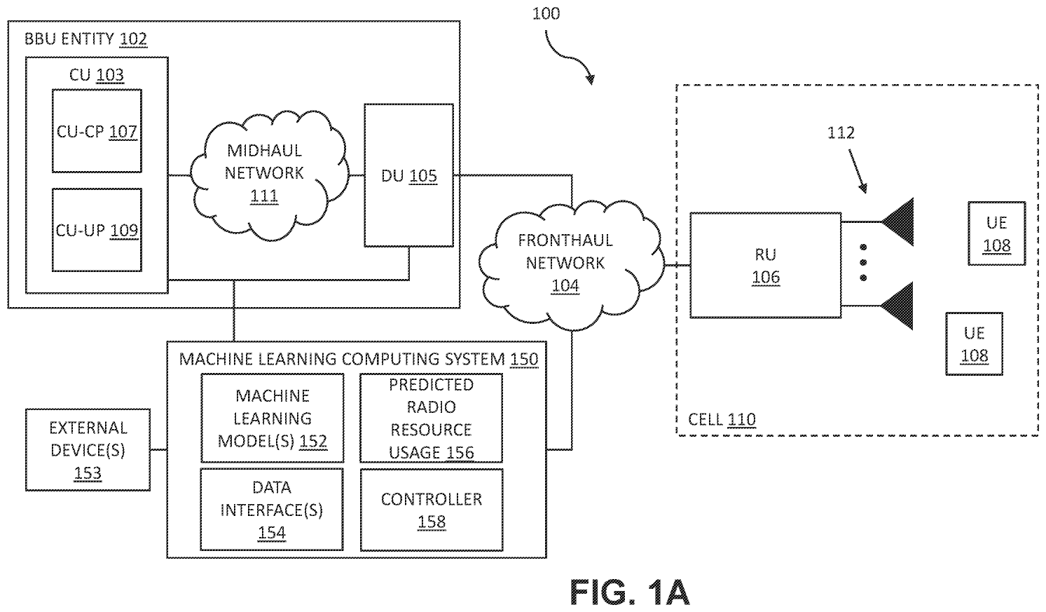

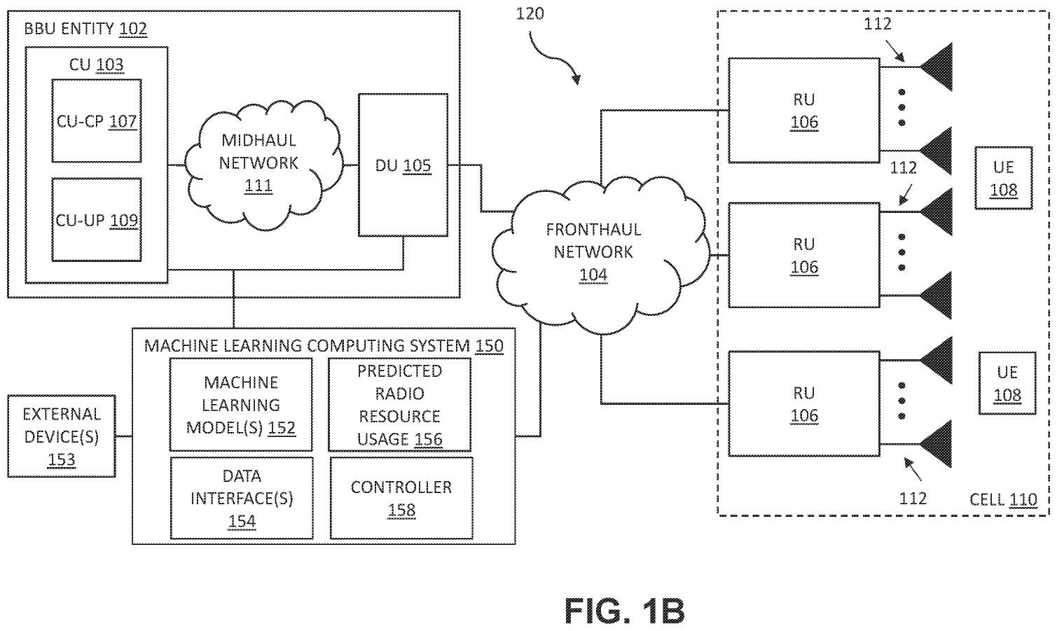

FIG. 1A is a block diagram illustrating an example base station 100 in which the techniques for network slice modification, addition, and deletion described herein can be implemented. In the particular example shown in FIG. 1A, the base station 100 includes one or more baseband unit (BBU) entities 102 communicatively coupled to a RU 106 via a fronthaul network 104. The base station 100 provides wireless service to various items of user equipment (UEs) 108 in a cell 110. Each BBU entity 102 can also be referred to simply as a “BBU.”

In the example shown in FIG. 1A, the one or more BBU entities 102 comprise one or more central units (CUs) 103 and one or more distributed units (DUs) 105. Each CU 103 implements Layer-3 and non-time critical Layer-2 functions for the associated base station 100. Each DU 105 is configured to implement the time critical Layer-2 functions and at least some of the Layer-1 (also referred to as the Physical Layer) functions for the associated base station 100. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109.

The RU 106 is configured to implement the control-plane and user-plane Layer-1 functions not implemented by the DU 105 as well as the radio frequency (RF) functions. The RU 106 is typically located remotely from the one or more BBU entities 102. In the example shown in FIG. 1A, the RU 106 is implemented as a physical network function (PNF) and is deployed in or near a physical location where radio coverage is to be provided in the cell 110. In the example shown in FIG. 1A, the RU 106 is communicatively coupled to the DU 105 using a fronthaul network 104. In some examples, the fronthaul network 104 is a switched Ethernet fronthaul network (for example, a switched Ethernet network that supports the Internet Protocol (IP)).

The RU 106 includes or is coupled to a set of antennas 112 via which downlink RF signals are radiated to UEs 108 and via which uplink RF signals transmitted by UEs 108 are received. In some examples, the set of antennas 112 includes two or four antennas. However, it should be understood that the set of antennas 112 can include two or more antennas 112. In one configuration (used, for example, in indoor deployments), the RU 106 is co-located with its respective set of antennas 112 and is remotely located from the one or more BBU entities 102 serving it. In another configuration (used, for example, in outdoor deployments), the antennas 112 for the RU 106 are deployed in a sectorized configuration (for example, mounted at the top of a tower or mast). In such a sectorized configuration, the RU 106 need not be co-located with the respective sets of antennas 112 and, for example, can be located at the base of the tower or mast structure, for example, and, possibly, co-located with its serving one or more BBU entities 102.

While the example shown in FIG. 1A shows a single CU-CP 107, a single CU-UP 109, a single DU 105, and a single RU 106 for the base station 100, it should be understood that this is an example and other numbers of BBU entities, components of the BBU entities, and/or RUs can also be used.

FIG. 1B is a block diagram illustrating an example base station 120 in which the techniques for network slice modification, addition, and deletion described herein can be implemented. In the particular example shown in FIG. 1B, the base station 120 includes one or more BBU entities 102 communicatively coupled to multiple RUs 106 via a fronthaul network 104. The base station 120 provides wireless service to various UEs 108 in a cell 110. Each BBU entity 102 can also be referred to simply as a “BBU.”

In the example shown in FIG. 1B, the one or more BBU entities 102 comprise one or more CUs 103 and one or more DUs 105. Each CU 103 implements Layer-3 and non-time critical Layer-2 functions for the associated base station 100. Each DU 105 is configured to implement the time critical Layer-2 functions and at least some of the Layer-1 (also referred to as the Physical Layer) functions for the associated base station 120. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109.

The RUs 106 are configured to implement the control-plane and user-plane Layer-1 functions not implemented by the DU 105 as well as the radio frequency (RF) functions. Each RU 106 is typically located remotely from the one or more BBU entities and located remotely from other RUs 106. In the example shown in FIG. 1B, each RU 106 is implemented as a physical network function (PNF) and is deployed in or near a physical location where radio coverage is to be provided in the cell 110. In the example shown in FIG. 1B, the RUs 106 are communicatively coupled to the DU 105 using a fronthaul network 104. In some examples, the fronthaul network 104 is a switched Ethernet fronthaul network (for example, a switched Ethernet network that supports the Internet Protocol (IP)).

Each of the RUs 106 includes or is coupled to a respective set of antennas 112 via which downlink RF signals are radiated to UEs 108 and via which uplink RF signals transmitted by UEs 108 are received. In some examples, each set of antennas 112 includes two or four antennas. However, it should be understood that each set of antennas 112 can include two or more antennas 112. In one configuration (used, for example, in indoor deployments), each RU 106 is co-located with its respective set of antennas 112 and is remotely located from the one or more BBU entities 102 serving it and the other RUs 106. In another configuration (used, for example, in outdoor deployments), the sets of antennas 112 for the RUs 106 are deployed in a sectorized configuration (for example, mounted at the top of a tower or mast). In such a sectorized configuration, the RUs 106 need not be co-located with the respective sets of antennas 112 and, for example, can be located at the base of the tower or mast structure, for example, and, possibly, co-located with the serving one or more BBU entities 102. Other configurations can be used.

The base stations 100, 120 that include the components shown in FIGS. 1A-1B can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. In some examples, the scalable cloud environment is implemented in a distributed manner. That is, the scalable cloud environment is implemented as a distributed scalable cloud environment comprising at least one central cloud, at least one edge cloud, and at least one radio cloud.

In some examples, one or more components of the one or more BBU entities 102 (for example, the CU 103, CU-CP 107, CU-UP 109, and/or DU 105) are implemented as a software virtualized entities that are executed in a scalable cloud environment on a cloud worker node under the control of the cloud native software executing on that cloud worker node. In some such examples, the DU 105 is communicatively coupled to at least one CU-CP 107 and at least one CU-UP 109, which can also be implemented as software virtualized entities. In some other examples, one or more components of the one or more BBU entities 102 (for example, the CU-CP 107, CU-UP 109, and/or DU 105) are implemented as a single virtualized entity executing on a single cloud worker node. In some examples, the at least one CU-CP 107 and the at least one CU-UP 109 can each be implemented as a single virtualized entity executing on the same cloud worker node or as a single virtualized entity executing on a different cloud worker node. However, it is to be understood that different configurations and examples can be implemented in other ways. For example, the CU 103 can be implemented using multiple CU-UPs 109 and using multiple virtualized entities executing on one or more cloud worker nodes. Moreover, it is to be understood that the CU 103 and DU 105 can be implemented in the same cloud (for example, together in a radio cloud or in an edge cloud). In some examples, the DU 105 is configured to be coupled to the CU-CP 107 and CU-UP 109 over a midhaul network 111 (for example, a network that supports the Internet Protocol (IP)). Other configurations and examples can be implemented in other ways.

As discussed above, there is a need to address the ability to improve usage of resources in networks based on real-time patterns. To help facilitate this for the base station 100, 120, a machine learning computing system 150 is communicatively coupled to one or more components of the base station 100, 120. The machine learning computing system 150 is configured to predict radio resource usage for the base station 100, 120, and one or more network slices are modified, added, or deleted based on the predicted radio resource usage.

In the examples shown in FIGS. 1A-1B, the machine learning computing system 150 is communicatively coupled to the BBU entity 102 and the RUs 106. In some examples, the machine learning computing system 150 is communicatively coupled to the CU 103, DU 105, and RUs 106. In other examples, the machine learning computing system 150 is communicatively coupled to a subset of the CU 103, DU 105, and RUs 106. In some examples, the machine learning computing system 150 is a general-purpose computing device (for example, a server) equipped with at least one (and optional more than one) graphics processing unit (GPU) for faster machine-learning-based processing. In some examples, the machine learning computing system 150 is implemented in more than one physical housing, each with at least one GPU. The machine learning computing system 150 is a host for one or more machine learning models 152 that predict radio resource usage for the base station. In some examples, the machine learning computing system 150 is communicatively coupled to and configured to serve a single base station. In other examples, the machine learning computing system 150 is communicatively coupled to and configured to serve multiple base stations. The number of base stations that the machine learning computing system 150 is communicatively coupled to can be determined based on deployment needs and scale.

In some examples, the machine learning computing system 150 includes one or more interfaces 154 configured to receive time data. The time data can include, for example, the current time of day, day of the week, and/or whether the current day is a holiday. In some examples, the time data is provided by one or more external devices 153 that are separate and distinct from the machine learning computing system 150. For example, the one or more external devices 153 configured to provide time data to the machine learning computing system 150 can be a tracker, sensor, or Internet-of-Things (IoT) device. In other examples, at least a portion of the time data is provided by an internal component of the machine learning computing system 150 (for example, an internal clock).

In some examples, the machine learning computing system 150 also includes one or more interfaces 154 configured to receive traffic data for the base station. The one or more interfaces 154 configured to receive traffic data can be the same interface(s) 154 or different interface(s) 154 compared to the one or more interfaces 154 configured to receive time data. The traffic data can include, for example, a number of UEs in the cell, traffic density in the cell, and/or types of UEs (based on capability) in the cell. In some examples, the traffic data is provided to the machine learning computing system 150 by one or more components of the base station (for example, the BBU entity and/or the RUs). In other examples, the traffic data is provided to the machine learning computing system 150 by a device that is external to the base station (for example, from a core network communicatively coupled to the base station).

In some examples, the machine learning computing system 150 also includes one or more interfaces 154 configured to receive quality of service (QoS) data for the base station. The one or more interfaces 154 configured to receive QoS data can be the same interface(s) 154 or different interface(s) 154 compared to the one or more interfaces 154 configured to receive time data and traffic data. The QoS data can include, for example, active QoS classification identifiers (QCIs) or active 5G QoS identifiers (5QIs) in the cell.

The machine learning computing system 150 includes a machine learning model 152 that is configured to determine predicted radio resource usage 156 of the base station. One or more components of the system are configured to modify, add, or delete a network slice based on the predicted radio resource usage 156. In some examples, the one or more components of the system are configured to modify a network slice based on the predicted radio resource usage 156. In some such examples, modifying a network slice includes changing one or more characteristics of a network slice (for example, frequency band, communication path, etc.) currently utilized by the system. In some examples, the one or more components of the system are configured to add a network slice based on the predicted radio resource usage 156. In some such examples, adding a network slice includes adding one or more VNFs (for example, CU-UP VNF, CU-CP VNF, DU VNF and/or UPF), modifying the routing between VNFs and/or between VNFs and RUs, and/or establishing a new end-to-end network connection using existing resources. In some examples, the one or more components of the system are configured to delete a network slice based on the predicted radio resource usage 156. In some such examples, the system is configured to reallocate resources from the deleted network slice for other use cases in the network.

In some examples, the machine learning computing system 150 is configured to provide control signals (for example, via controller 158) to the BBU entity 102 and/or RUs 106. In other examples, the predicted radio resource usage 156 is output to a component of the system (for example, the BBU entity 102), and the component of the system generates and provides control signals for modifying, adding, or deleting network slices.

In some examples, the machine learning model 152 is a multinomial regression model, and the machine learning computing system 150 utilizes the time data, the traffic data, and the QoS data as independent variables in a predictor function of the machine learning model 152. In such examples, the predicted radio resource usage 156 of the base station is the dependent variable in the predictor function of the machine learning model 152. Each independent variable in the predictor function is associated with a specific weight/coefficient determined via training and the weights/coefficients can be updated during operation of the system.

The time data (including current time of day and day of week) is encoded and used by the machine learning model 152 in a manner that does not apply a higher weight to a particular time of day by default (for example, where 11:00 AM is weighted higher than 10:00 AM by virtue of being associated with a larger number). In some examples, the time of day is divided into segments (for example, 15-minute increments) and the predictor function utilizes a binary variable for indicating that the current time falls within a particular segment. For example, a one can be used to indicate that the current time is within a particular time segment, and a zero can be used to indicate that the current time is not within a particular segment. Similarly, the predictor function can utilize a binary variable for indicating that the current day of the week is a particular day of the week. For example, a one can be used to indicate that the current day of the week is a particular day of the week, and a zero can be used to indicate that the current day of the week is not a particular day of the week.

In examples where the time data also includes information regarding whether the current day is a holiday, this information is also encoded and used by the machine learning model 152 in a manner that does not apply a higher weight to a particular holiday by default. In some examples, the information regarding whether the current day is a holiday can be indicated using a binary variable such that any day that is a holiday will be encoded as a first state (for example, using a one) and any day that is not a holiday will be encoded as the other state (for example, using a zero). In other examples, each specific holiday can be associated with a different independent variable that is binary in a manner similar to the time segments discussed above.

In some examples, the traffic data is encoded and used as a single independent variable in the machine learning model 152. For example, where the traffic data includes a number of UEs in the cell, the independent variable in the predictor function can correspond to the number of UEs in the cell. In other examples, the traffic data can be encoded in different ways. For example, a cell can be divided into sub-areas and the traffic data for each sub-area can be a different independent variable. In some such examples, each independent variable can correspond to the number of UEs in sub-areas of the cell.

In some examples, the QoS data is encoded and used by the machine learning model 152 in a manner that does not apply a higher weight to a particular QoS by default (for example, where a QCI of 9 is weighted higher than a QCI of 8 by virtue of being associated with a larger number). In some examples, the predictor function utilizes a binary variable for each QCI indicating that a threshold utilization for a QCI is met. For example, a one can be used to indicate that the utilization for a particular QCI exceeds the threshold for that particular QCI, and a zero can be used to indicate that the utilization for a particular QCI does not exceed the threshold for that particular QCI. In other examples, the predictor function utilizes a binary variable for different groups of QCIs indicating that a threshold utilization for the group of QCIs is met. For example, a one can be used to indicate that the utilization for a particular group of QCIs exceeds the threshold for that particular group of QCIs, and a zero can be used to indicate that the utilization for a particular group of QCIs does not exceed the threshold for that particular group of QCIs.

In some examples, the predicted radio resource usage 156 output by the machine learning model 152 indicates the combination of network slices to be utilized by the base station to meet real-time needs of the network. In some examples, each combination of network slices to be used by the base station is encoded as a distinct output (dependent variable) of the predictor function of the machine learning model 152. In some examples, the output of the machine learning model 152 is an integer that corresponds to the particular combination of network slices to be used by the base station. Each distinct output corresponds to a different number of network slices and/or specific characteristics of the network slices (frequency band, communication path, etc.).

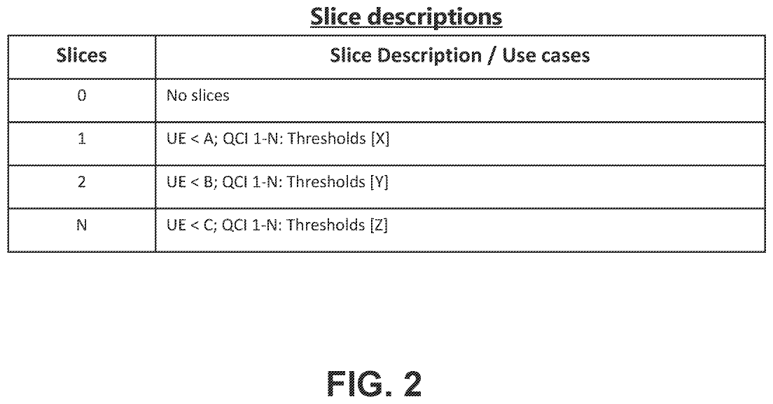

While the different combinations of network slices can be encoded as a numerical output, the numerical output represents additional information that is assumed in the machine learning model 152. In some examples, each combination of networks slices corresponds to different amounts of UEs, frequency bands, and/or ranges of QCIs. A simplified table of network slices and associated thresholds is shown in FIG. 2. In some examples, the thresholds associated with each numerical output corresponding to a particular combination of network slices increase as the numerical output value increases. In such examples, the values A, B, and C in FIG. 2 correspond to different thresholds for a number of UEs in the cell and have the following relationship: A<B<C. Similarly, in some such examples, the values X, Y, and Z correspond to different thresholds for utilization of QCIs and have the following relationship: X<Y<Z.

The particular thresholds and the specific values for the thresholds can be selected based on the specific needs and desired performance of the network. The values for the thresholds in each machine learning model 152 will vary depending on the particular independent variables and scope of that particular machine learning model 152. In some examples, the particular thresholds and specific values for the thresholds can be selected based on billing and pricing (for example, additional/dedicated network slice(s) added for a particular venue based on pricing arrangement), levels of utilization for QCIs or 5QIs, and/or utilization per frequency band or band class (for example, CBRS, C-band, etc.).

In order to reliably predict the radio resource usage for the base station, the machine learning model 152 is trained in order to determine the weights/coefficients using supervised learning prior to operation. In some examples, synthetic (non-real world) time data, traffic data, and QoS data is generated for the independent variables and synthetic predicted radio resource usage is generated for dependent variables. In other examples, sensors can be distributed throughout the cell to generate measured time data and traffic data that is used for training. In some examples, the weights/coefficients are determined using an iterative procedure or other supervised learning training techniques. In some examples, the objective for training the machine learning model 152 is to optimize resource utilization while meeting SLA requirements, which can provide more equitable system resource availability based on real-time demand.

Once the machine learning model 152 is trained, the machine learning computing system 150 is configured to use the time data, the traffic data, and the QoS data as inputs for the machine learning model 152 and determine a predicted radio resource usage 156 for the base station. In some examples, the machine learning computing system 150 is configured to perform additional learning during operation and adapt the weights/coefficients based on real world time data, traffic data, and/or QoS data for the base station. Other performance parameters can also be used for the additional learning during operation.

In some examples, the number of independent variables of the machine learning model 152 can be selected during training based on the desired level of accuracy and computational load demands for the machine learning model 152. In theory, a greater number of independent variables for the time data, traffic data, and QoS data can provide a more accurate prediction of the radio resource usage of the base station assuming that the machine learning model 152 is sufficiently trained. However, the computational load demands and the time required for training increase when using a higher number of independent variables.

In some examples, the number of possible distinct outputs (for example, number of network slices) of the machine learning model 152 can be selected during training based on the needs and capabilities of the system. Some factors that can be used to determine the number of distinct outputs can include desired level of service for UEs in various traffic scenarios, system capabilities for transport (for example, multicasting), system capabilities for core network (for example, available computational resources), and the like. In general, the number of network slices is limited by the capabilities of the system, but a greater number of possible distinct outputs of the machine learning model 152 could help provide better service and user experience compared to a lower number of possible distinct outputs. However, the machine learning model 152 will likely take longer to train if there is a large number of possible distinct outputs.

While a single machine learning model 152 may provide sufficient accuracy for some applications, it may be desirable or necessary to increase the accuracy of the predicted radio resource usage 156 of the base station. One potential approach for increasing the accuracy of the predicted radio resource usage 156 of the base station is to use multiple machine learning models 152 that are each specific to a subset of the time data, traffic data, and/or QoS data. This approach reduces the number of independent variables, which reduces the complexity of the predictor function and can result in reduced computational load and/or increased accuracy of the output.

In some examples, multiple machine learning models 152 directed to specific subsets of the time data are utilized by the machine learning computing system 150. In some such examples, each respective machine learning model 152 is directed to a particular time of day (for example, morning, afternoon, or evening). In other such examples, each respective machine learning model 152 is directed to a particular day of the week (for example, Monday, Tuesday, etc.) or grouped day of the week (for example, weekdays or weekends). In other such examples, each respective machine learning model 152 is directed to a particular holiday status (for example, holiday or non-holiday).

In some examples, multiple machine learning models 152 directed to specific subsets of the traffic data are utilized by the machine learning computing system 150. In some such examples, each respective machine learning model 152 is directed to a specific sub-area of the cell and uses only traffic data for that specific sub-area as an input. In other such examples, each respective machine learning model 152 is directed to a specific operator and uses only traffic data for that specific operator as an input. In some examples where the machine learning models 152 are operator-specific, a particular network slice is modified, added, or deleted depending on whether it is needed for any operator. For example, if a single operator machine learning model 152 indicates that the network slice is needed, then the network slice is added. However, if no operator machine learning model 152 indicates that the network slice is needed, then the network slice is deleted.

In some examples, multiple machine learning models 152 directed to specific subsets of QoS data are utilized by the machine learning computing system 150. In some such examples, each respective machine learning model 152 is directed to a specific QoS classification identifier (QCI), QCI range, 5G QoS identifier (5QI), or 5QI range. In some such examples, all of the machine learning models 152 use the same time data and traffic data as inputs for the independent variables, but each machine learning model 152 predicts the radio resource usage for a specific QCI, QCI range, 5QI, or 5QI range. In other examples, each machine learning model 152 uses traffic data that is specific to the particular QCI, QCI range, 5QI, or 5QI range and predicts the radio resource usage for a specific QCI, QCI range, 5QI, or 5QI range.

In some examples, multiple machine learning models 152 directed to specific frequency bands or band classes are utilized by the machine learning computing system 150. In such examples, each respective machine learning model 152 is directed to a specific frequency band or band class used in the cell. In some such examples, all of the machine learning models 152 use the same time data, traffic data, and QoS data as inputs for the independent variables, but each machine learning model 152 predicts the radio resource usage for a specific frequency band or band class. In other examples, each machine learning model 152 uses traffic data that is specific to the particular frequency band or band class (for example, number of UEs utilizing the particular frequency band or band class) and predicts the radio resource usage for that specific frequency band or band class.

In some examples, multiple machine learning models 152 directed to a combination of the subsets discussed above can be used to increase the accuracy of the predicted radio resource usage 156 and/or enable different functionality depending on the needs of the system. For example, some of the machine learning models 152 can be operator-specific and directed to a particular frequency band or band class. In such examples, the network slices specific to particular operators can be modified, added, or deleted depending on the outputs of the machine learning models 152.

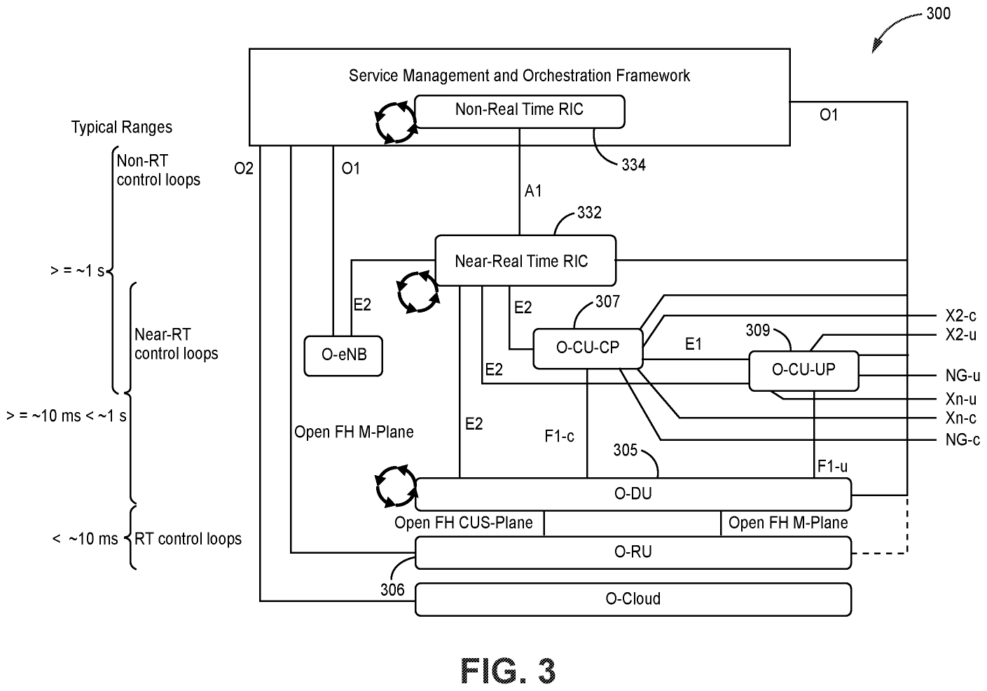

FIG. 3 is a block diagram illustrating an example base station 300 in which the techniques for radio resource usage described herein can be implemented. In the particular example shown in FIG. 3, the base station 300 includes one or more central units (CUs), one or more distributed units (DUs), and one or more radio units (RUs). Each RU is located remotely from each CU and DU serving it.

The base station 300 is implemented in accordance with one or more public standards and specifications. In some examples, the base station 300 is implemented using the logical RAN nodes, functional splits, and fronthaul interfaces defined by the Open Radio Access Network (O-RAN) Alliance. In the example shown in FIG. 3, each CU, DU, and RU is implemented as an O-RAN central unit (O-CU), O-RAN distributed unit (O-DU) 305, and O-RAN radio unit (O-RU) 306, respectively, in accordance with the O-RAN specification.

In the example shown in FIG. 3, the base station 300 includes a single O-CU, which is split between an O-CU-CP 307 that handles control-plane functions and an O-CU-UP 309 that handles user-plane functions. The O-CU comprises a logical node hosting Packet Data Convergence Protocol (PDCP), Radio Resource Control (RRC), Service Data Adaptation Protocol (SDAP), and other control functions. Therefore, each O-CU implements the gNB controller functions such as the transfer of user data, mobility control, radio access network sharing, positioning, session management, etc. The O-CU(s) control the operation of the O-DUs 305 over an interface (including F1-c and F1-u for the control plane and user plane, respectively).

In the example shown in FIG. 3, the single O-CU handles control plane functions, user plane functions, some non-real-time functions, and/or PDCP processing. The O-CU-CP 307 may communicate with at least one wireless service provider's Next Generation Cores (NGC) using a 5G NG-c interface and the O-CU-UP 309 may communicate with at least one wireless service provider's NGC using a 5G NG-u interface.

Each O-DU 305 comprises a logical node hosting (performing processing for) Radio Link Control (RLC) and Media Access Control (MAC) layers, as well as optionally the upper or higher portion of the Physical (PHY) layer (where the PHY layer is split between the DU and RU). In other words, the O-DUs 305 implement a subset of the gNB functions, depending on the functional split (between O-CU and O-DU 305). In some configurations, the Layer-3 processing (of the 5G air interface) may be implemented in the O-CU and the Layer-2 processing (of the 5G air interface) may be implemented in the O-DU 305.

The O-RU 306 comprises a logical node hosting the portion of the PHY layer not implemented in the O-DU 305 (that is, the lower portion of the PHY layer) as well as implementing the basic RF and antenna functions. In some examples, the O-RUs 306 may communicate baseband signal data to the O-DUs 305 on the Open Fronthaul CUS-Plane or Open Fronthaul M-plane interface. In some examples, the O-RU 306 may implement at least some of the Layer-1 and/or Layer-2 processing. In some configurations, the O-RUs 306 may have multiple ETHERNET ports and can communicate with multiple switches.

Although the O-CU (including the O-CU-CP 307 and O-CU-UP 309), O-DU 305, and O-RUs 306 are described as separate logical entities, one or more of them can be implemented together using shared physical hardware and/or software. For example, in the example shown in FIG. 3, for each cell, the O-CU (including the O-CU-CP 307 and O-CU-UP 309) and O-DU 305 serving that cell could be physically implemented together using shared hardware and/or software, whereas each O-RU 306 would be physically implemented using separate hardware and/or software. Alternatively, the O-CU(s) (including the O-CU-CP 307 and O-CU-UP 309) may be remotely located from the O-DU(s) 305.

In the example shown in FIG. 3, the base station 300 further includes a non-real time RAN intelligent controller (RIC) 334 and a near-real time RIC 332. The non-real time RIC 334 and the near-real time RIC 332 are separate entities in the O-RAN architecture and serve different purposes. In some examples, the non-real time RIC 334 is implemented as a standalone application in a cloud network. In other examples, the non-real time RIC 334 is integrated with a Device Management System (DMS) or Service Orchestration (SO) tool. In some examples, the near-real time RIC 332 is implemented as a standalone application in a cloud network. In other examples, the near-real time RIC 332 is embedded in the O-CU. The non-real time RIC 334 and/or the near-real time RIC 332 can also be deployed in other ways.

The non-real time RIC 334 is responsible for non-real time flows in the system (typically greater than or equal to 1 second) and configured to execute one or more machine learning models, which are also referred to as “rApps.” The near-real time RIC 332 is responsible for near-real time flows in the system (typically 10 ms to 1 second) and configured to execute one or more machine learning models, which are also referred to as “xApps.”

In some examples, the non-real time RIC 334 shown in FIG. 3 can be configured to operate in a manner similar to the machine learning computing system 150 described above with respect to FIGS. 1A-2. In some such examples, the functionality of the machine learning computing system 150 is implemented as an rApp that is configured to run on the non-real time RIC 334. The non-real time RIC 334 is configured to predict radio resource usage in a manner similar to that described above, and the base station 300 is configured to modify, add, or delete network slices based on the predicted radio resource usage.

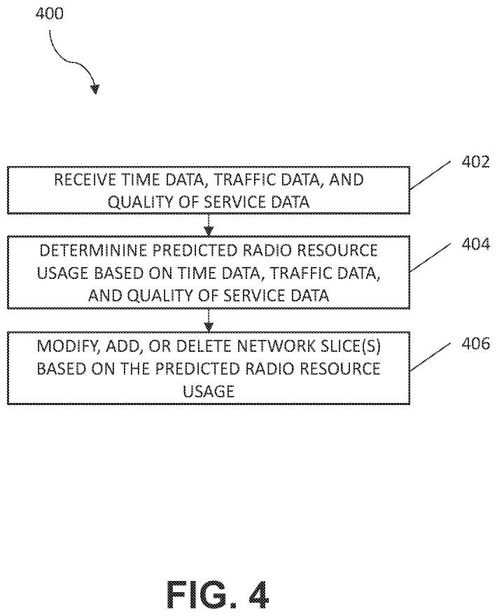

FIG. 4 is a flow diagram of an example method 400 for machine learning based network slice modification, addition, and deletion. The common features discussed above with respect to the base stations in FIGS. 1A-3 can include similar characteristics to those discussed with respect to method 400 and vice versa. In some examples, the method 400 is performed by a base station (for example, base station 100, 120, 300).

The method 400 begins with receiving time data, traffic data, and quality of service (QoS) data (block 402). In some examples, the time data includes the current time of day, the current day of the week, and/or whether the current day is a holiday. In some examples, the traffic data includes a number of UEs in the cell, traffic density in the cell, and/or types of UEs (based on capability) in the cell. In some examples, the QoS data includes active QoS classification identifiers (QCIs) or active 5G QoS identifiers (5QIs).

The method 400 includes determining predicted radio resource usage based on the time data, the traffic data, and the QoS data (block 404). In some examples, predicting radio resource usage includes predicting the number of network slices needed to meet the requirements of SLAs for user equipment in the cell. In some examples, predicting the radio resource usage includes predicting a particular combination of network slices (including number of network slices and characteristics of the network slices) needed to meet the requirements of SLAs for user equipment in the cell. In some examples, predicting radio resource usage includes determining whether the traffic data and/or the QoS data meets a particular threshold (for example, threshold number of UEs and/or QCI utilization).

The method 400 includes dynamically modifying, adding, or deleting one or more network slices based on the predicted radio resource usage (block 406). In some examples, dynamically modifying, adding, or deleting one or more network slices based on the predicted radio resource usage includes modifying one or more characteristics of a current network slice. In some examples, dynamically modifying, adding, or deleting one or more network slices based on the predicted radio resource usage includes adding at least one network slice. In some examples, dynamically modifying, adding, or deleting one or more network slices based on the predicted radio resource usage includes deleting at least one network slice. In some examples, dynamically modifying, adding, or deleting one or more network slices based on the predicted radio resource usage includes adding at least one network slice and deleting at least one network slice. This situation can occur, for example, when a network slice for one operator is deleted and a network slice for a different operator is added using those resources.

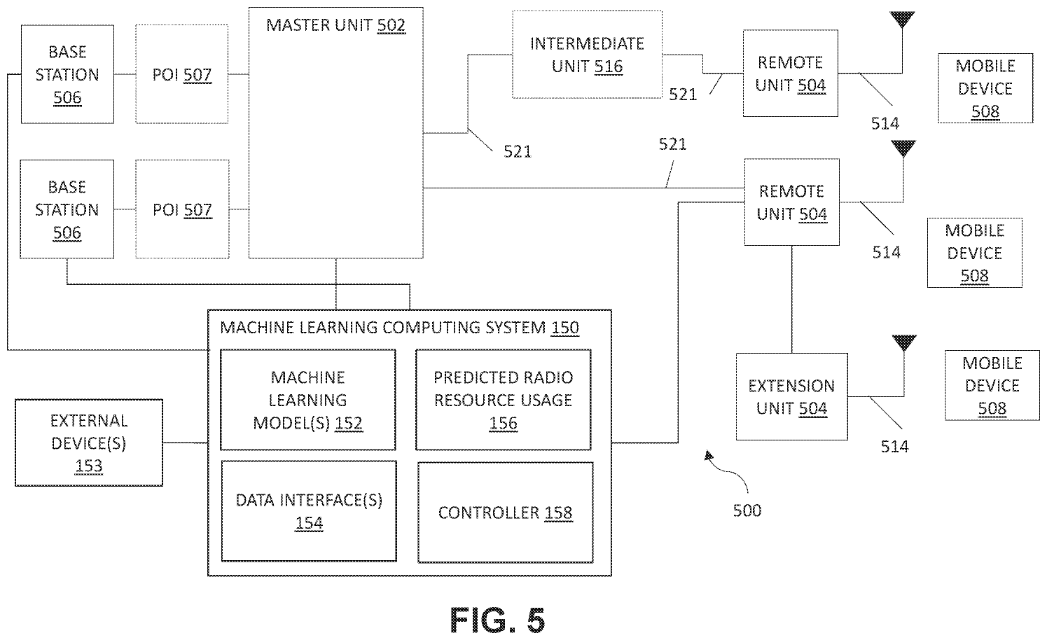

FIG. 5 is a block diagram of an example distributed antenna system (DAS) in which the techniques for radio resource usage described herein can be implemented. In the example of FIG. 5, the DAS 500 includes one or more master units 502 (also referred to as “host units” or “central area nodes” or “central units”) and one or more remote antenna units 504 (also referred to as “remote units” or “radiating points”) that are communicatively coupled to the one or more master units 502. In this example, the DAS 500 comprises a digital DAS, in which DAS traffic is distributed between the master units 502 and the remote antenna units 504 in digital form. The DAS 500 can be deployed at a site to provide wireless coverage and capacity for one or more wireless network operators. The site may be, for example, a building or campus or other grouping of buildings (used, for example, by one or more businesses, governments, or other enterprise entities) or some other public venue (such as a hotel, resort, amusement park, hospital, shopping center, airport, university campus, arena, or an outdoor area such as a ski area, stadium or a densely-populated downtown area).

The master unit 502 is communicatively coupled to the plurality of base stations 506. One or more of the base stations 506 can be co-located with the respective master unit 502 to which it is coupled (for example, where the base station 506 is dedicated to providing base station capacity to the DAS 500). Also, one or more of the base stations 506 can be located remotely from the respective master unit 502 to which it is coupled (for example, where the base station 506 is a macro base station providing base station capacity to a macro cell in addition to providing capacity to the DAS 500). In this latter case, a master unit 502 can be coupled to a donor antenna using an over-the-air repeater in order to wirelessly communicate with the remotely located base station.

The base stations 506 can be implemented in a traditional manner in which a base band unit (BBU) is deployed at the same location with a remote radio head (RRH) to which it is coupled, where the BBU and RRH are coupled to each other using optical fibers over which front haul data is communicated as streams of digital IQ samples (for example, in a format that complies with one of the Common Public Radio Interface (CPRI), Open Base Station Architecture Initiative (OBSAI), and Open RAN (O-RAN) families of specifications). Also, the base stations 506 can be implemented in other ways (for example, using a centralized radio access network (C-RAN) topology where multiple BBUs are deployed together in a central location, where each of BBU is coupled to one or more RRHs that are deployed in the area in which wireless service is to be provided. Also, the base station 506 can be implemented as a small cell base station in which the BBU and RRH functions are deployed together in a single package.

The master unit 502 can be configured to use wideband interfaces or narrowband interfaces to the base stations 506. Also, the master unit 502 can be configured to interface with the base stations 506 using analog radio frequency (RF) interfaces or digital interfaces (for example, using a CPRI, OBSAI, or O-RAN digital interface). In some examples, the master unit 502 interfaces with the base stations 506 via one or more wireless interface nodes (not shown). A wireless interface node can be located, for example, at a base station hotel, and group a particular part of a RF installation to transfer to the master unit 502.

Traditionally, a master unit 502 interfaces with one or more base stations 506 using the analog radio frequency signals that each base station 506 communicates to and from a mobile device 508 (also referred to as “mobile units” or “user equipment”) of a user using a suitable air interface standard. Although the devices 508 are referred to here as “mobile” devices 508, it is to be understood that the devices 508 need not be mobile in ordinary use (for example, where the device 508 is integrated into, or is coupled to, a sensor unit that is deployed in a fixed location and that periodically wirelessly communicates with a gateway or other device). The DAS 500 operates as a distributed repeater for such radio frequency signals. RF signals transmitted from each base station 506 (also referred to herein as “downlink RF signals”) are received at the master unit. In such examples, the master unit 502 uses the downlink RF signals to generate a downlink transport signal that is distributed to one or more of the remote antenna units 504. Each such remote antenna unit 504 receives the downlink transport signal and reconstructs a version of the downlink RF signals based on the downlink transport signal and causes the reconstructed downlink RF signals to be radiated from an antenna 514 coupled to or included in that remote antenna unit 504.

In some aspects, the master unit 502 is directly coupled to the remote antenna units 504. In such aspects, the master unit 502 is coupled to the remote antenna units 504 using cables 521. For example, the cables 521 can include optical fiber or Ethernet cable complying with the Category 5, Category 5e, Category 6, Category 6A, or Category 7 specifications. Future communication medium specifications used for Ethernet signals are also within the scope of the present disclosure.

A similar process can be performed in the uplink direction. RF signals transmitted from mobile devices 508 (also referred to herein as “uplink RF signals”) are received at one or more remote antenna units 504 via an antenna 514. Each remote antenna unit 504 uses the uplink RF signals to generate an uplink transport signal that is transmitted from the remote antenna unit 504 to a master unit 502. The master unit 502 receives uplink transport signals transmitted from one or more remote antenna units 504 coupled to it. The master unit 502 can combine data or signals communicated via the uplink transport signals from multiple remote antenna units 504 (for example, where the DAS 500 is implemented as a digital DAS 500, by digitally summing corresponding digital samples received from the various remote antenna units 504) and generates uplink RF signals from the combined data or signals. In such examples, the master unit 502 communicates the generated uplink RF signals to one or more base stations 506. In this way, the coverage of the base stations 506 can be expanded using the DAS 500.

As noted above, in the example shown in FIG. 5, the DAS 500 is implemented as a digital DAS. In some examples of a “digital” DAS, real digital signals are communicated between the master unit 502 and the remote antenna units 504. In some examples of a “digital” DAS, signals received from and provided to the base stations 506 and mobile devices 508 are used to produce digital in-phase (I) and quadrature (Q) samples, which are communicated between the master unit 502 and remote antenna units 504. It is important to note that this digital IQ representation of the original signals received from the base stations 506 and from the mobile units still maintains the original modulation (that is, the change in the instantaneous amplitude, phase, or frequency of a carrier) used to convey telephony or data information pursuant to the cellular air interface standard used for wirelessly communicating between the base stations 506 and the mobile units. Examples of such cellular air interface standards include, for example, the Global System for Mobile Communication (GSM), Universal Mobile Telecommunications System (UMTS), High-Speed Downlink Packet Access (HSDPA), Long-Term Evolution (LTE), Citizens Broadband Radio Service (CBRS), and fifth generation New Radio (5G NR) air interface standards. Also, each stream of digital IQ samples represents or includes a portion of the frequency spectrum. For example, the digital IQ samples can represent a single radio access network carrier (for example, a 5G NR carrier with 50 MHz or 500 MHz signal bandwidth) onto which voice or data information has been modulated using a 5G NR air interface. However, it is to be understood that each such stream can also represent multiple carriers (for example, in a band of the frequency spectrum or a sub-band of a given band of the frequency spectrum).

In the example shown in FIG. 5, the master unit 502 can be configured to interface with one or more base stations 506 using an analog RF interface (for example, via the analog RF interface of an RRH or a small cell base station). In some examples, the base stations 506 can be coupled to the master unit 502 using a network of attenuators, combiners, splitters, amplifiers, filters, cross-connects, etc., which is referred to collectively as a point-of-interface (POI) 507. This is done so that, in the downlink, the desired set of RF carriers output by the base stations 506 can be extracted, combined, and routed to the appropriate master unit 502, and so that, in the uplink, the desired set of carriers output by the master unit 502 can be extracted, combined, and routed to the appropriate interface of each base station 506. In other examples, the POI 507 can be part of the master unit 502.

In the example shown in FIG. 5, in the downlink, the master unit 502 can produce digital IQ samples from an analog signal received at certain radio frequencies. These digital IQ samples can also be filtered, amplified, attenuated, and/or re-sampled or decimated to a lower sample rate. The digital samples can be produced in other ways. Each stream of digital IQ samples represents a portion of the frequency spectrum output by one or more base stations 506.

Likewise, in the uplink, the master unit 502 can produce an uplink analog signal from one or more streams of digital IQ samples received from one or more remote antenna units 504 by digitally combining streams of digital IQ samples that represent the same carriers or frequency bands or sub-bands received from multiple remote antenna units 504 (for example, by digitally summing corresponding digital IQ samples from the various remote antenna units 504), performing a digital-to-analog process on the real samples in order to produce an IF or baseband analog signal, and up-converting the IF or baseband analog signal to the desired RF frequency. The digital IQ samples can also be filtered, amplified, attenuated, and/or re-sampled or interpolated to a higher sample rate, before and/or after being combined.

In the example shown in FIG. 5, the master unit 502 can be configured to interface with one or more base stations 506 using a digital interface (in addition to, or instead of) interfacing with one or more base stations 506 via an analog RF interface. For example, the master unit 502 can be configured to interact directly with one or more BBUs using the digital IQ interface that is used for communicating between the BBUs and an RRHs (for example, using the CPRI serial digital IQ interface).

In the downlink, the master unit 502 terminates one or more downlink streams of digital IQ samples provided to it from one or more BBUs and, if necessary, converts (by re-sampling, synchronizing, combining, separating, gain adjusting, etc.) them into downlink streams of digital IQ samples compatible with the remote antenna units 504 used in the DAS 500. In the uplink, the master unit 502 receives uplink streams of digital IQ samples from one or more remote antenna units 504, digitally combining streams of digital IQ samples that represent the same carriers or frequency bands or sub-bands received from multiple remote antenna units 504 (for example, by digitally summing corresponding digital IQ samples received from the various remote antenna units 504), and, if necessary, converts (by re-sampling, synchronizing, combining, separating, gain adjusting, etc.) them into uplink streams of digital IQ samples compatible with the one or more BBUs that are coupled to that master unit 502.

In the downlink, each remote antenna unit 504 receives streams of digital IQ samples from the master unit 502, where each stream of digital IQ samples represents a portion of the radio frequency spectrum output by one or more base stations 506. Each remote antenna unit 504 generates, from the downlink digital IQ samples, one or more downlink RF signals for radiation from the one or more antennas coupled to that remote antenna unit 504 for reception by any mobile devices 508 in the associated coverage area. In the uplink, each remote antenna unit 504 receives one or more uplink radio frequency signals transmitted from any mobile devices 508 in the associated coverage area, generates one or more uplink streams of digital IQ samples derived from the received one or more uplink radio frequency signals, and transmits them to the master unit 502.

Each remote antenna unit 504 can be communicatively coupled directly to one or more master units 502 or indirectly via one or more other remote antenna units 504 and/or via one or more intermediate units 516 (also referred to as “expansion units” or “transport expansion nodes”). The latter approach can be done, for example, in order to increase the number of remote antenna units 504 that a single master unit 502 can feed, to increase the master-unit-to-remote-antenna-unit distance, and/or to reduce the amount of cabling needed to couple a master unit 502 to its associated remote antenna units 504. The expansion units are coupled to the master unit 502 via one or more cables 521.

In the example DAS 500 shown in FIG. 5, a remote antenna unit 504 is shown having another co-located remote antenna unit 505 (also referred to herein as an “extension unit”) communicatively coupled to it. Subtending a co-located extension remote antenna unit 505 from another remote antenna unit 504 can be done in order to expand the number of frequency bands that are radiated from that same location and/or to support MIMO service (for example, where different co-located remote antenna units radiate and receive different MIMO streams for a single MIMO frequency band). The remote antenna unit 504 is communicatively coupled to the “extension” remote antenna units 505 using a fiber optic cable, a multi-conductor cable, coaxial cable, or the like. In such an implementation, the remote antenna units 505 are coupled to the master unit 502 of the DAS 500 via the remote antenna unit 504.

In some examples, one or more components of the DAS 500 adjusted based on the predicted radio resource usage from the machine learning computer system 150 in a manner similar to that described above with respect to FIGS. 1A-4. The machine learning computer system 150 can be communicatively coupled to the one or more components of the DAS 500 either directly or indirectly. For example, the routing of signals from the master unit 502 to the remote antenna units 504, 505 can be adjusted as part of modifying, adding, or deleting a network slice.

Other examples are implemented in other ways.

The example techniques described herein reduce the operating expenses associated with modifying, adding, or deleting network slices compared to typical implementations by automating this process using the machine learning computing system to predict radio resource usage of a base station. The example techniques described herein also improve user experience by modifying, adding, or deleting network slices using the machine learning computing system to predict the real time traffic needs and meet the requirements of Service Level Agreements (SLAs). Further, when dynamically deleting network slice(s) when unneeded, the core, transport, and/or radio resources from the deleted network slice(s) can be saved resulting in reduced costs or reallocated elsewhere to provide better service in the cell to other UEs.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### EXAMPLE EMBODIMENTS

Example 1 includes a system, comprising: at least one baseband unit (BBU); one or more radio units communicatively coupled to the at least one BBU; one or more antennas communicatively coupled to the one or more radio units, wherein each respective radio unit of the one or more radio units is communicatively coupled to a respective subset of the one or more antennas; wherein the at least one BBU, the one or more radio units, and the one or more antennas are configured to implement a base station for wirelessly communicating with user equipment; and a machine learning computing system configured to: receive time data, traffic data, and quality of service (QoS) data; and determine a predicted radio resource usage of the base station based on the time data, the traffic data, and the QoS data; wherein the system is configured to dynamically modify, add, or delete a network slice based on the predicted radio resource usage of the base station.

Example 2 includes the system of Example 1, wherein the time data, the traffic data, and the QoS data includes: time of day; day of week; a number of user equipment wirelessly communicating with the base station; and active quality of service identifiers.

Example 3 includes the system of any of Examples 1-2, wherein at least some of the time data, the traffic data, and/or the QoS data are provided by one or more devices external to the system.

Example 4 includes the system of any of Examples 1-3, wherein the system is configured to dynamically add a network slice based on the predicted radio resource usage of the base station.

Example 5 includes the system of any of Examples 1-4, wherein the system is configured to dynamically delete a network slice based on the predicted radio resource usage of the base station.

Example 6 includes the system of any of Examples 1-5, wherein the system is configured to dynamically modify a network slice based on the predicted radio resource usage of the base station.

Example 7 includes the system of any of Examples 1-6, wherein the network slice includes a share of transport resources, core network resources, and radio access network resources.

Example 8 includes the system of any of Examples 1-7, wherein the machine learning computing system is configured to utilize the time data, the traffic data, and the QoS data as inputs to a plurality of machine learning models, wherein each machine learning model of the plurality of machine learning models is directed to a respective one or more quality of service identifiers.

Example 9 includes the system of any of Examples 1-8, wherein the machine learning computing system is configured to utilize the time data, the traffic data, and the QoS data as inputs to a plurality of machine learning models, wherein each machine learning model of the plurality of machine learning models is directed to a respective frequency band.

Example 10 includes the system of any of Examples 1-9, wherein the machine learning computing system is configured to utilize the time data, the traffic data, and the QoS data as inputs to a plurality of machine learning models, wherein each machine learning model of the plurality of machine learning models is directed to a respective operator.

Example 11 includes the system of any of Examples 1-10, wherein the one or more radio units includes a plurality of radio units, wherein the one or more antennas includes a plurality of antennas.

Example 12 includes the system of any of Examples 1-11, wherein the BBU includes a central unit communicatively coupled to a distributed unit, wherein the distributed unit is communicatively coupled to the one or more radio units.

Example 13 includes the system of any of Examples 11-12, wherein the machine learning computing system is implemented in a radio access network intelligent controller.

Example 14 includes a method, comprising: receiving time data, traffic data, and quality of service (QoS) data; determining a predicted radio resource usage of a base station based on the time data, the traffic data, and the QoS data, wherein the base station includes at least one baseband unit (BBU), one or more radio units communicatively coupled to the at least one BBU, and one or more antennas communicatively coupled to the one or more radio units, wherein each respective radio unit of the one or more radio units is communicatively coupled to a respective subset of the one or more antennas, wherein the at least one BBU, the one or more radio units, and the one or more antennas are configured to implement a base station for wirelessly communicating with user equipment; and dynamically modifying, adding, or deleting one or more network slices based on the predicted radio resource usage of the base station.

Example 15 includes the method of any of Examples 14-15, wherein the time data, the traffic data, and the QoS data includes: time of day; day of week; a number of user equipment wirelessly communicating with the base station; and active quality of service identifiers.

Example 16 includes the method of any of Examples 14-15, wherein receiving time data and traffic data includes: receiving at least some of the time data from one or more devices external to the base station; receiving at least some of the traffic data from one or more devices external to the base station; and/or receiving at least some of the QoS data from one or more devices external to the base station.

Example 17 includes the method of any of Examples 14-16, wherein dynamically modifying, adding, or deleting one or more network slices based on the predicted radio resource usage of the base station includes adding a network slice based on the predicted radio resource usage of the base station.

Example 18 includes the method of any of Examples 14-17, wherein dynamically modifying, adding, or deleting one or more network slices based on the predicted radio resource usage of the base station includes deleting a network slice based on the predicted radio resource usage of the base station.

Example 19 includes the method of any of Examples 14-18, wherein dynamically modifying, adding, or deleting one or more network slices based on the predicted radio resource usage of the base station includes modifying a network slice based on the predicted radio resource usage of the base station.

Example 20 includes the method of any of Examples 14-19, wherein each network slice of the one or more network slices includes a share of transport resources, core network resources, and radio access network resources.

Example 21 includes the method of any of Examples 14-20, wherein determining a predicted radio resource usage of a base station based on the time data, the traffic data, and the QoS data includes utilizing the time data, the traffic data, and the QoS data as inputs to a plurality of machine learning models, wherein each machine learning model of the plurality of machine learning models is directed to a respective one or more quality of service identifiers.

Example 22 includes the method of any of Examples 14-21, wherein determining a predicted radio resource usage of a base station based on the time data, the traffic data, and the QoS data includes utilizing the time data, the traffic data, and the QoS data as inputs to a plurality of machine learning models, wherein each machine learning model of the plurality of machine learning models is directed to a respective frequency band.

Example 23 includes the method of any of Examples 14-22, wherein determining a predicted radio resource usage of a base station based on the time data, the traffic data, and the QoS data includes utilizing the time data, the traffic data, and the QoS data as inputs to a plurality of machine learning models, wherein each machine learning model of the plurality of machine learning models is directed to a respective operator.

Example 24 includes a system, comprising: a distributed antenna system including: a master unit communicatively coupled to a base station; one or more remote antenna units communicatively coupled to the master unit, wherein the one or more remote antenna units are located remotely from the master unit, wherein the one or more remote antenna units are configured to communicate wireless signals with user equipment in one or more coverage zones; and a machine learning computing system configured to: receive time data, traffic data, and quality of service (QoS) data; and determine a predicted radio resource usage of the base station based on the time data, the traffic data, and the QoS data; wherein the system is configured to dynamically modify, add, or delete a network slice based on the predicted radio resource usage of the base station.

Example 25 includes the system of Example 24, wherein the time data, the traffic data, and the QoS data includes: time of day; day of week; a number of user equipment wirelessly communicating with the one or more remote antenna units; and active quality of service identifiers.

Example 26 includes the system of any of Examples 24-25, wherein at least some of the time data, the traffic data, and/or the QoS data are provided by one or more devices external to the system.

Example 27 includes the system of any of Examples 24-26, wherein the system is configured to dynamically add a network slice based on the predicted radio resource usage of the base station.

Example 28 includes the system of any of Examples 24-27, wherein the system is configured to dynamically delete a network slice based on the predicted radio resource usage of the base station.

Example 29 includes the system of any of Examples 24-28, wherein the system is configured to dynamically modify a network slice based on the predicted radio resource usage of the base station.

Example 30 includes the system of any of Examples 24-29, wherein the network slice includes a share of transport resources, core network resources, and radio access network resources.

Example 31 includes the system of any of Examples 24-30, wherein the machine learning computing system is configured to utilize the time data, the traffic data, and the QoS data as inputs to a plurality of machine learning models, wherein each machine learning model of the plurality of machine learning models is directed to a respective one or more quality of service identifiers.

Example 32 includes the system of any of Examples 24-31, wherein the machine learning computing system is configured to utilize the time data, the traffic data, and the QoS data as inputs to a plurality of machine learning models, wherein each machine learning model of the plurality of machine learning models is directed to a respective frequency band.

Example 33 includes the system of any of Examples 24-32, wherein the machine learning computing system is configured to utilize the time data, the traffic data, and the QoS data as inputs to a plurality of machine learning models, wherein each machine learning model of the plurality of machine learning models is directed to a respective operator.

Example 34 includes the system of any of Examples 24-33, wherein the one or more remote antenna units includes a plurality of remote antenna units.

Example 35 includes the system of any of Examples 24-34, wherein the base station includes a central unit communicatively coupled to a distributed unit, wherein the distributed unit is communicatively coupled to the one or more remote antenna units.

Example 36 includes the system of any of Examples 24-35, wherein the machine learning computing system is implemented in a radio access network intelligent controller.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A system, comprising:
at least one baseband unit (BBU);
one or more radio units communicatively coupled to the at least one BBU;
one or more antennas communicatively coupled to the one or more radio units, wherein each respective radio unit of the one or more radio units is communicatively coupled to a respective subset of the one or more antennas;
wherein the at least one BBU, the one or more radio units, and the one or more antennas are configured to implement a base station for wirelessly communicating with user equipment; and
a machine learning computing system configured to:
receive time data, traffic data, and quality of service (QoS) data; and
determine a predicted radio resource usage of the base station based on the time data, the traffic data, and the QoS data;
wherein the system is configured to dynamically modify, add, or delete a network slice based on the predicted radio resource usage of the base station.

2. The system of claim 1, wherein the time data, the traffic data, and the QoS data includes:
time of day;
day of week;
a number of user equipment wirelessly communicating with the base station; and
active quality of service identifiers.

3. (canceled)

4. The system of claim 1, wherein the system is configured to dynamically add or delete a network slice based on the predicted radio resource usage of the base station.

5. (canceled)

6. The system of claim 1, wherein the system is configured to dynamically modify a network slice based on the predicted radio resource usage of the base station.

7. The system of claim 1, wherein the network slice includes a share of transport resources, core network resources, and radio access network resources.

8. The system of claim 1, wherein the machine learning computing system is configured to utilize the time data, the traffic data, and the QoS data as inputs to a plurality of machine learning models, wherein each machine learning model of the plurality of machine learning models is directed to a respective one or more quality of service identifiers, a respective frequency band, and/or a respective operator.

9. (canceled)

10. (canceled)

11. The system of claim 1, wherein the one or more radio units includes a plurality of radio units, wherein the one or more antennas includes a plurality of antennas.

12. (canceled)

13. (canceled)

14. A method, comprising:
receiving time data, traffic data, and quality of service (QoS) data;
determining a predicted radio resource usage of a base station based on the time data, the traffic data, and the QoS data, wherein the base station includes at least one baseband unit (BBU), one or more radio units communicatively coupled to the at least one BBU, and one or more antennas communicatively coupled to the one or more radio units, wherein each respective radio unit of the one or more radio units is communicatively coupled to a respective subset of the one or more antennas, wherein the at least one BBU, the one or more radio units, and the one or more antennas are configured to implement a base station for wirelessly communicating with user equipment; and
dynamically modifying, adding, or deleting one or more network slices based on the predicted radio resource usage of the base station.

15. The method of claim 14, wherein the time data, the traffic data, and the QoS data includes:
time of day;
day of week;
a number of user equipment wirelessly communicating with the base station; and
active quality of service identifiers.

16. The method of claim 14, wherein receiving time data and traffic data includes:
receiving at least some of the time data from one or more devices external to the base station;
receiving at least some of the traffic data from one or more devices external to the base station; and/or
receiving at least some of the QoS data from one or more devices external to the base station.

17. The method of claim 14, wherein dynamically modifying, adding, or deleting one or more network slices based on the predicted radio resource usage of the base station includes adding or deleting a network slice based on the predicted radio resource usage of the base station.

18. (canceled)

19. The method of claim 14, wherein dynamically modifying, adding, or deleting one or more network slices based on the predicted radio resource usage of the base station includes modifying a network slice based on the predicted radio resource usage of the base station.

20. (canceled)

21. The method of claim 14, wherein determining a predicted radio resource usage of a base station based on the time data, the traffic data, and the QoS data includes utilizing the time data, the traffic data, and the QoS data as inputs to a plurality of machine learning models, wherein each machine learning model of the plurality of machine learning models is directed to a respective one or more quality of service identifiers, a respective frequency band, and/or a respective operator.

22. (canceled)

23. (canceled)

24. A system, comprising:
a distributed antenna system including:
a master unit communicatively coupled to a base station;
one or more remote antenna units communicatively coupled to the master unit, wherein the one or more remote antenna units are located remotely from the master unit, wherein the one or more remote antenna units are configured to communicate wireless signals with user equipment in one or more coverage zones; and
a machine learning computing system configured to:
receive time data, traffic data, and quality of service (QoS) data; and
determine a predicted radio resource usage of the base station based on the time data, the traffic data, and the QoS data;
wherein the system is configured to dynamically modify, add, or delete a network slice based on the predicted radio resource usage of the base station.

25. The system of claim 24, wherein the time data, the traffic data, and the QoS data includes:
time of day;
day of week;
a number of user equipment wirelessly communicating with the one or more remote antenna units; and
active quality of service identifiers.

26. (canceled)

27. The system of claim 24, wherein the system is configured to dynamically add or delete a network slice based on the predicted radio resource usage of the base station.

28. (canceled)

29. The system of claim 24, wherein the system is configured to dynamically modify a network slice based on the predicted radio resource usage of the base station.

30. The system of claim 24, wherein the network slice includes a share of transport resources, core network resources, and radio access network resources.

31. The system of claim 24, wherein the machine learning computing system is configured to utilize the time data, the traffic data, and the QoS data as inputs to a plurality of machine learning models, wherein each machine learning model of the plurality of machine learning models is directed to a respective one or more quality of service identifiers, a respective frequency band, and/or a respective operator.

32. (canceled)

33. (canceled)

34. The system of claim 24, wherein the one or more remote antenna units includes a plurality of remote antenna units.

35. (canceled)

36. (canceled)
